(19) United States
(12) Patent Application Publication
(10) Pub. No.: US 2008/0017005 A1
(43) Pub. Date: Jan. 24, 2008

(54) Light path molding apparatus of cutting machine tool

(76) Inventor: Hsin-Chih Tung, Chung-Li City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/488,031

(22) Filed: Jul. 18, 2006

(51) Int. Cl. B26D 7/27

(52) U.S. Cl. 83/522.15; 83/522.11

(57) ABSTRACT

A light path molding apparatus of cutting machine tool, wherein the cutting machine tool comprises a shaft and a circular saw blade. The light path molding apparatus comprises an outer casing, a circuit board, a plurality of fixing structures and a plurality of light emitting diodes, wherein the outer casing has a containing base is disposed at the shaft and a cover is covered on the containing base; the circuit board is disposed in the containing base; the fixing structures are disposed on the circuit board for fixing and electrically connecting with a mercury in vertical; each of the light emitting diodes is electrically connected with the circuit board and passed through a circumference wall of the containing base for emitting scattering light, and a portion of scattering light is shielded by the circular saw blade to form a light path.

### BACKGROUND OF THE INVENTION

1. Field of the Invention

The present invention relates to light path molding apparatus of a cutting machine tool, and more particularly to a light path molding apparatus that is applied to a cutting machine tool, and light paths are molded as cut lines on cut objects.

2. Description of the Prior Art

Circular saw machines are commonly used by the carpentry industries for cutting the cut objects such as wood. Reference is made to FIG. 1 which is a side schematic view of a light path molding apparatus of the prior art. A circular saw blade 92 is driven to rotate by a motor via a shaft 90 for cutting the cut objects (not shown).

In order to increase accuracy of the circular saw machine of the prior art, a light path molding apparatus is provided, as shown in FIG. 1 to FIG. 3. The light path molding apparatus 80 comprises a bottom plate 85 and a top cover 81 is covered on the bottom plate 85. The circular saw blade 92 is clipped between the light path molding apparatus 80 and the shaft 90. Light 70 is projected along the circular saw blade 92 to form a light path for being a cut line on the cut objects.

The light path molding apparatus 80 has a laser light 70 in the top cover 81 thereof for producing straight light 71 and the straight light 71 is emitted from a gaps 811 of the top cover 81. A plurality of circuits 76 are placed in the bottom plate 85 and a plurality of batteries 77 are electrically connected with the circuits 76. The top cover 81 is correspondingly fixed with the bottom plate 85 by screws. And the light path molding apparatus 80 is enabled on by a centrifugal switch (not shown) disposed in the top cover 81 or the bottom plate 85.

However, the light 71 emitted from the laser light 70 is at a distance to the circular saw blade 92, so the formed light path by the light 71 is not match the real position of cutting for the circular saw blade 92.

Furthermore, the circular saw blade 92 is driven to rotate by a circular saw machine in high speed about thousands rpm. Hence, if the batteries 77 are disposed in horizontal, it is easily to fall of between the batteries 77 and the circuits 76 due to centrifugal force produced by high-speed rotation to cause unstable light path and unexpected security questions.

Furthermore, a large number of components are dispersed on the top cover 81 or the bottom plate 85 so as to complicate the structure and reduce assembly efficiency.

The inventor of the present invention recognizes the above shortage should be corrected and special effort has been paid to research this field. The present invention is presented with reasonable design and good effect to resolve the above problems.

### SUMMARY OF THE INVENTION

It is a primary object of the present invention to provide a light path molding apparatus of a cutting machine tool, wherein a portion of scattering light emitted by light emitting diodes is shielded by a circular saw blade to form a light and shade boundary line that is the required light path. In other words, location of the light path is the cutting location of the circular saw blade.

It is another object of the present invention to provide mercury batteries are fixed in vertical so that it is convenient to take apart or install the batteries and the batteries are not easily fallen off.

It is another object of the present invention to provide that all components are centralized on one side of a containing base so as to simplify the structure and increase assembly efficiency.

For achieving the objectives stated above, the cutting machine tool of the present invention comprises a shaft and a circular saw blade, the circular saw blade is clipped between the light path molding apparatus and the shaft. The light path molding apparatus of the present invention comprises an outer casing has a containing base is disposed at the shaft and a cover is covered on the containing base, and the containing base has a circumference wall; a circuit board is disposed in the containing base; a plurality of fixing structures, each of the fixing structures is disposed on the circuit board for fixing mercury batteries in vertical, and the circuit board, the fixing structures each and the batteries electrically connected with each other; and a plurality of light emitting diodes, each of the light emitting diodes is electrically connected with the circuit board, and a portion of scattering light emitted via the circumference wall is shielded by the circular saw blade to form a light path.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

The above and further advantages of this invention may be better understood by referring to the following description, taken in conjunction with the accompanying drawings, in which:

FIG. 1 is a side schematic view of a light path molding apparatus of the prior art;

FIG. 2 is a 2D schematic view of a top cover of a light path molding apparatus of the prior art;

FIG. 3 is a 2D schematic view of a bottom plate of a light path molding apparatus of the prior art;

FIG. 4 is a schematic view of using state of a light path molding apparatus according to the present invention;

FIG. 5 is a side cross-sectional view of a light path molding apparatus according to the present invention;

FIG. 6 is a 2D schematic view of a containing base of a light path molding apparatus according to the present invention;

FIG. 7 is an exploded perspective view of a fixing structure of a light path molding apparatus according to the present invention;

FIG. 8 is an assembled perspective view of a fixing structure of a light path molding apparatus of the FIG. 7 according to the present invention; and

FIG. 9 is a cross-sectional view of a fixing structure and a circuit board of a light path molding apparatus according to the present invention.

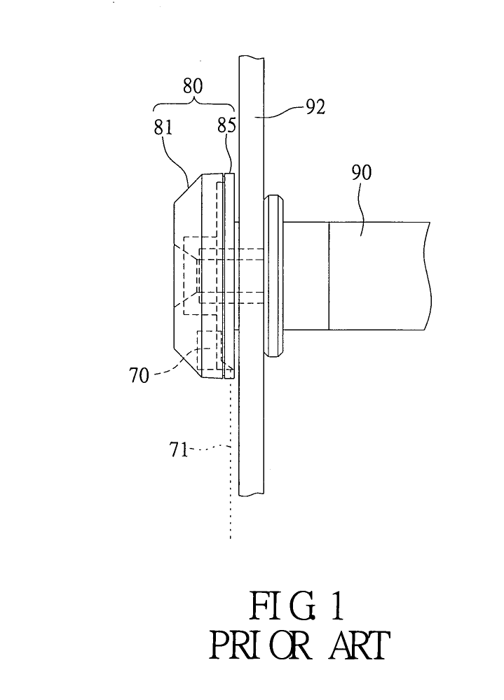

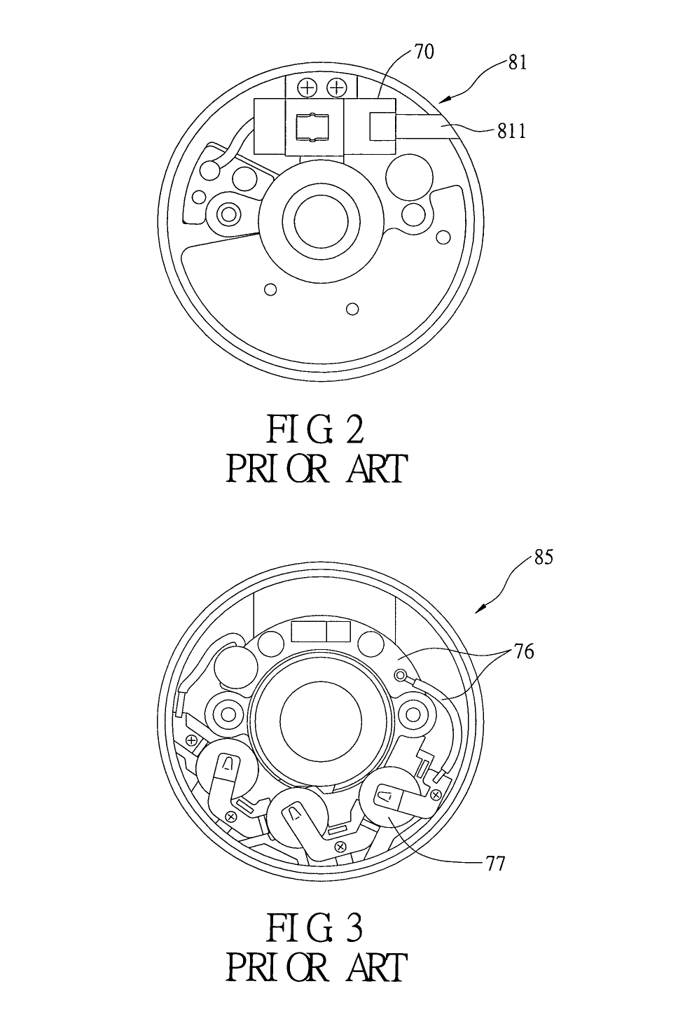

The drawings will be described further in connection with the following detailed description of the present invention.

### DETAILED DESCRIPTION OF THE PREFERRED EMBODIMENTS

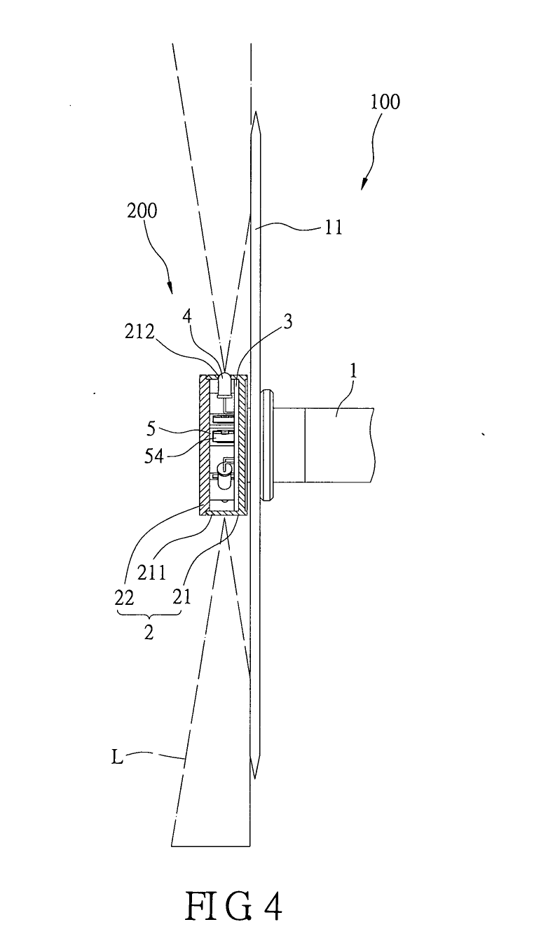

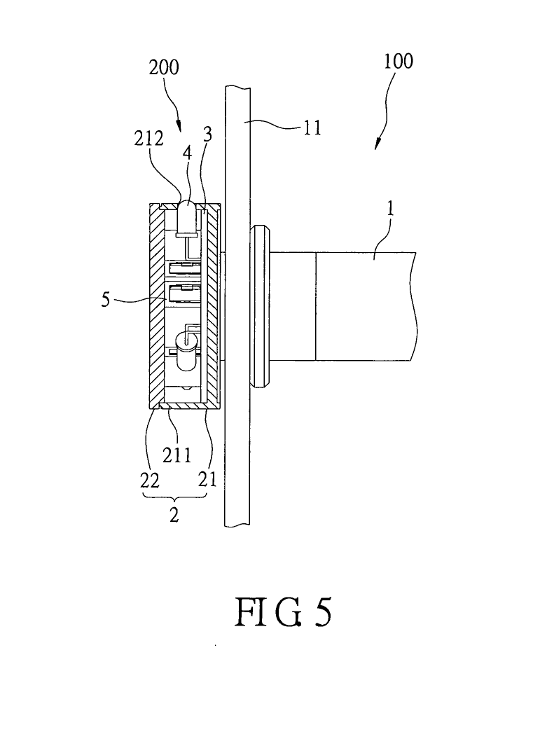

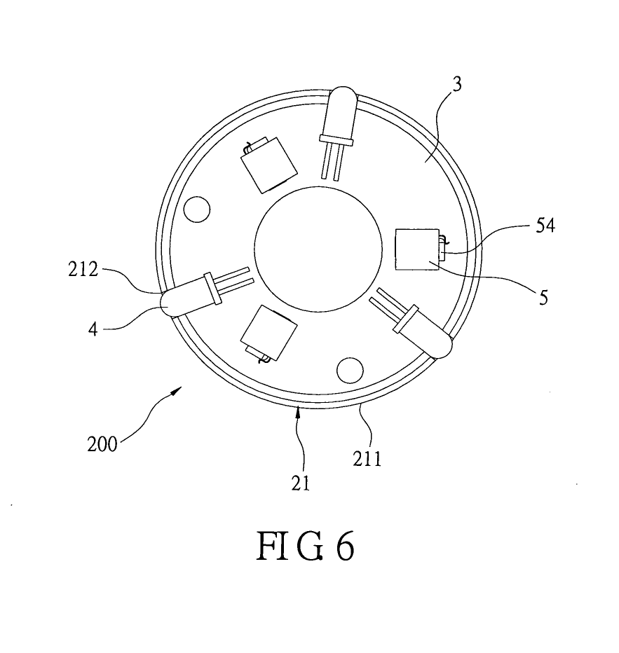

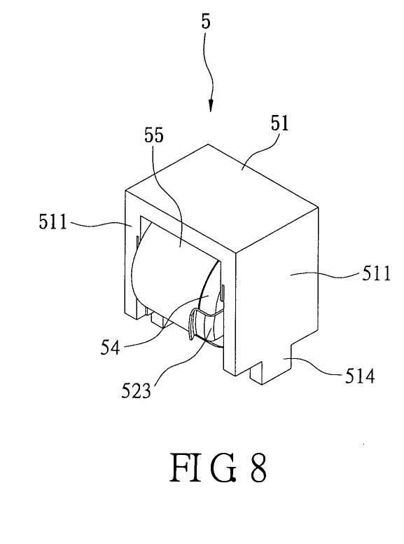

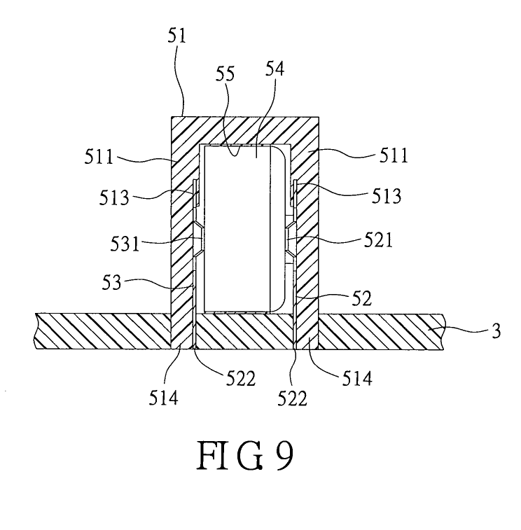

References are made from FIG. 4 to FIG. 9. A light path molding apparatus of a cutting machine tool, wherein the cutting machine tool 100 comprises has a shaft 1 and a circular saw blade 11, the circular saw blade 11 is clipped between the light path molding apparatus 200 and the shaft 1, and the circular saw blade 11 is driven to rotate by the shaft 1 of the cutting machine tool 100. The light path molding apparatus 200 emits scattering light L is shielded by the circular saw blade 11 to form a obvious light path on cut objects (not shown) for being cut.

The light path molding apparatus 200 comprises an outer casing 2, a circuit board 3, a plurality of light emitting diodes 4 and a plurality of fixing structures 5.

The outer casing 2 has a containing base 21 is disposed at the shaft 1 and a cover 22 is covered on the containing base 21, the notch-shaped containing base 21 has a circumference wall 211, and the circumference wall 211 has a plurality of through holes 212.

The circuit board 3 is disposed in the containing base 21. Each of the fixing structures 5 are disposed on the circuit board 3 for fixing batteries 54, and each of the light emitting diodes 4 is electrically connected with the circuit board 3. In a preferred embodiment, the circuit board 3 is a surrounding plate is corresponding to the circumference wall 211 so as to obtain a maximum layout space of electronic components. The light emitting diodes 4 are disposed around the circuit board 3 at the same distance, each of the light emitting diodes 4 emits scattering light L from each of the through holes 212 of the circumference wall 211. As shown in FIG. 4, a portion of scattering light L emitted is shielded by the circular saw blade 11 to form a light path for being a cut line.

Each of the fixing structures 5 comprises an insulating frame 51 is disposed on the circuit board 3, and a first electricity conductive element 52 and a second electricity conductive element 53. Wherein the insulating frame 51 is a case with two relative side portions 511, each free end of the two side portions has a foot portion 514 and the insulating frame 51 is disposed on the circuit board 3 by the two foot portions 514. The two side portions 511 have relative inner walls 512, and each of the inner walls 512 has an inserting portion 513.

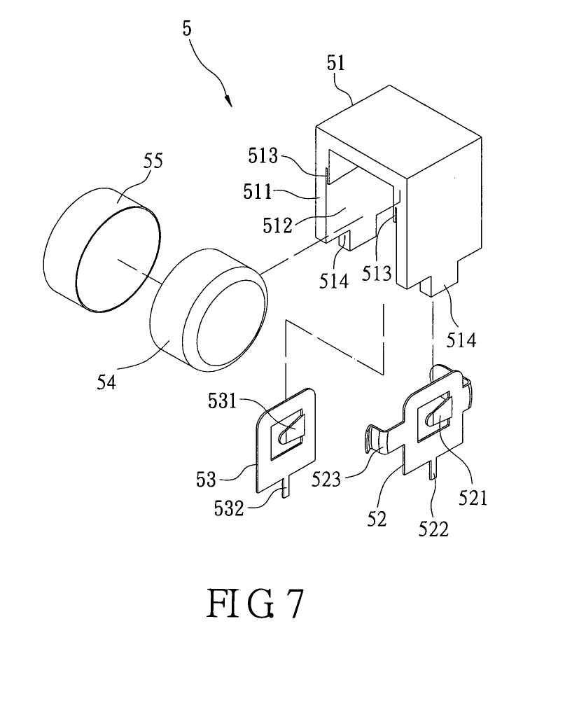

The first electricity conductive element 52 and the second electricity conductive element 53 are respectively have a conductive piece 521, 531 for providing electric contact to the batteries 54 and a soldering pin 522, 532 for being soldered on the circuit board 3, and the first electricity conductive element 52 and the second electricity conductive element 53 are respectively inserted in the inserting portions 513. The mercury batteries 54 are clipped in vertical between so that the circuit board 3, the first electricity conductive element 52, the second electricity conductive element 53 and the batteries 54 are electrically connected with each other for providing electricity to the light emitting diodes 4. And one of the conductive pieces of the first electricity conductive element 52 and the second electricity conductive element 53 has a stopping portion 523, as shown in FIG. 7, the stopping portion 523 is disposed at the first electricity conductive element 52 for stopping the batteries 54 without falling off.

Because the batteries 54 are erectly clipped between the first electricity conductive element 52 and the second electricity conductive element 53, two electrodes of the batteries 54 are respectively electrically touched to the conductive piece 521 of the first electricity conductive element 52 and the conductive piece 531 of the second electricity conductive element 53, the first electricity conductive element 52 and the second electricity conductive element 53 are electrically connected with the circuit board 3 by the soldering pins 522, 532, and the light emitting diodes 4 are electrically connected with the circuit board 3 so as to form a circuit loop to provide the light emitting diodes 4 emit the scattering light L.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

In conclusion, the light path molding apparatus of a cutting machine tool of the present invention has the following advantages:

The light emitted diodes 4 are used to emit scattering light L and a portion of scattering light L is shielded by the circular saw blade 11 to form a light and shade boundary line that is the required light path. In other words, location of the light path is the cutting location of the circular saw blade 11 that is to provide good accuracy.

Whereby design of the fixing structure 5 make the batteries 54 be fixed in vertical so that it is convenient to take apart or install the batteries 54 and the batteries 54 are not easily fallen off.

All components are centralized on one side of the containing base 21 so as to simplify the structure and increase assembly efficiency.

What is claimed is:

1. A light path molding apparatus of a cutting machine tool, comprising:
a shaft and a circular saw blade, the circular saw blade clipped between the light path molding apparatus and the shaft, and the light path molding apparatus including:
an outer casing having a containing base disposed at the shaft and a cover covered on the containing base, and the containing base having a circumference wall;
a circuit board disposed in the containing base;
a plurality of fixing structures, each of the fixing structures disposed on the circuit board for fixing batteries, and the circuit board, each of the fixing structures and each of the batteries electrically connected with each other; and
a plurality of light emitting diodes, each of the light emitting diodes electrically connected with the circuit board, and a portion of scattering light emitted via the circumference wall shielded by the circular saw blade to form a light path.

2. The light path molding apparatus of the cutting machine tool as claimed in claim 1, wherein the containing base of the outer casing has a plurality of through holes in the circumference wall thereof, and each of the through holes is corresponding to each of the light emitting diodes to emit the scattering light.

3. The light path molding apparatus of the cutting machine tool as claimed in claim 1, wherein the circuit board has a circumference wall is corresponding to the containing base, and the light emitting diodes are disposed equidistant from each other around the circuit board.

4. The light path molding apparatus of the cutting machine tool as claimed in claim 1, wherein the fixing structures each have an insulating frame is disposed on the circuit board and a pair of a first electricity conductive element and a second electricity conductive element are respectively disposed at two sides of the insulating frame, two electrodes of the battery are respectively touched to the first electricity conductive element and the second electricity conductive element, and the first electricity conductive element and the second electricity conductive element are electrically connected with the circuit board.

5. The light path molding apparatus of the cutting machine tool as claimed in claim 4, wherein the insulating frame is a case with two relative side portions, each free end of the two side portions is disposed on the circuit board and the two side portions have relative inner walls, and the first electricity conductive element and the second electricity conductive element are respectively positioned on the inner walls of the two side portions.

6. The light path molding apparatus of the cutting machine tool as claimed in claim 5, wherein the two side portions of the insulating frame respectively have a foot portion, and the two side portions are disposed on the circuit board by the two foot portions.

7. The light path molding apparatus of the cutting machine tool as claimed in claim 5, wherein each of the two side portions of the insulating frame has an inserting portion is disposed on a relative inner wall thereof, and the first electricity conductive element and the second electricity conductive element are respectively inserted in the two inserting portions.

8. The light path molding apparatus of the cutting machine tool as claimed in claim 4, wherein the first electricity conductive element and the second electricity conductive element respectively have a conductive piece for providing electric contact to the batteries and a soldering pin for being soldered on the circuit board.

9. The light path molding apparatus of the cutting machine tool as claimed in claim 8, wherein one of the first electricity conductive element and the second electricity conductive element has a stopping portion.
